(19) United States
(12) Patent Application Publication
(10) Pub. No.: US 2020/0262202 A1
(43) Pub. Date: Aug. 20, 2020

(54) LIQUID EJECTING HEAD AND LIQUID EJECTING APPARATUS

(71) Applicant: SEIKO EPSON CORPORATION, Tokyo (JP)

(72) Inventor: Takahiro KATAKURA, Okaya-shi (JP)

(73) Assignee: SEIKO EPSON CORPORATION, Tokyo (JP)

(21) Appl. No.: 16/793,591

(22) Filed: Feb. 18, 2020

(30) Foreign Application Priority Data
Feb. 20, 2019 (JP) 2019-028676

(51) Int. Cl. B41J 2/14

(52) U.S. Cl. CPC B41J 2/14209; B41J 2002/14338; B41J 2/14274

(57) ABSTRACT

A liquid ejecting head includes a chamber forming portion in which a pressure chamber is formed, the pressure chamber being provided with a supply port for supplying a liquid thereto and a nozzle for ejecting the liquid therefrom, an diaphragm that has a first surface being a wall surface of the pressure chamber and a second surface opposite to the first surface and that oscillates and thereby applies pressure to the pressure chamber, support walls that are disposed so as to be in contact with the second surface and so as to protrude in a direction intersecting the second surface, and piezoelectric elements that are disposed at the diaphragm and that oscillates the diaphragm. The support walls and the piezoelectric elements are provided so as to serve for the pressure chamber, and longitudinal directions of the support walls are parallel to respective longitudinal directions of the piezoelectric elements.

The present application is based on, and claims priority from JP Application Serial Number 2019-028676, filed Feb. 20, 2019, the disclosure of which is hereby incorporated by reference herein in its entirety.

### BACKGROUND

### 1. Technical Field

The present disclosure relates to a liquid ejecting head and to a liquid ejecting apparatus.

### 2. Related Art

Various types of liquid ejecting heads have been used in liquid ejecting apparatuses. A type of liquid ejecting head includes pressure chambers each of which has a nozzle formed therein. A liquid is ejected by applying pressure to the pressure chambers. For example, JP-A-2003-311956 discloses an ink jet head in which an actuator unit is disposed so as to serve for a plurality of pressure chambers, and ink is ejected from an ink discharge port that are in communication with two pressure chambers.

In the case of ejecting a viscous liquid or ejecting a liquid at a high speed, it is necessary to improve the capability of ejecting the liquid without decreasing the rigidity of the structure having the pressure chambers. However, simply increasing the number of the pressure chambers, as is the case for the ink jet head proposed by JP-A-2003-311956, may not lead to an improvement in the liquid ejection capability since this increases the surface area of a flow-path wall formed by an diaphragm and may lead to a decrease in the rigidity of the structure having pressure chambers. If the surface area of the flow-path wall formed by the diaphragm remains the same, simply increasing the number of pressure chambers as the ink jet head proposed by JP-A-2003-311956 may lead to a decrease in the volume of each pressure chamber, which results in an increase in the flow path resistance of the liquid in each pressure chamber. This may not lead to an improvement in the liquid ejection capability, either.

### SUMMARY

According to an aspect of the present disclosure, a liquid ejecting head includes a chamber forming portion in which a pressure chamber is formed, the pressure chamber being provided with a supply port for supplying a liquid thereto and a nozzle for ejecting the liquid therefrom, an diaphragm that has a first surface being a wall surface of the pressure chamber and a second surface opposite to the first surface and that oscillates and thereby applies pressure to the pressure chamber, support walls that are disposed so as to be in contact with the second surface and so as to protrude in a direction intersecting the second surface, and piezoelectric elements that are disposed on the diaphragm and that oscillates the diaphragm. In the liquid ejecting head, the support walls and the piezoelectric elements are provided so as to serve for the pressure chamber, and longitudinal directions of the support walls are parallel to respective longitudinal directions of the piezoelectric elements.

### BRIEF DESCRIPTION OF THE DRAWINGS

FIG. 1 is a schematic view illustrating a liquid ejecting apparatus according to Example 1 of the present disclosure.

FIG. 2 is an enlarged perspective view illustrating a region serving for one nozzle of a liquid ejecting head in the liquid ejecting apparatus according to Example 1 of the present disclosure.

FIG. 3 is an enlarged front view illustrating a region serving for one nozzle of the liquid ejecting head in the liquid ejecting apparatus according to Example 1 of the present disclosure.

FIG. 4 is an enlarged plan view schematically illustrating a region serving for one nozzle of the liquid ejecting head in the liquid ejecting apparatus according to Example 1 of the present disclosure.

FIG. 5 is an enlarged perspective view schematically illustrating a region serving for a plurality of nozzles of the liquid ejecting head in the liquid ejecting apparatus according to Example 1 of the present disclosure.

FIG. 6 is a schematic view illustrating a driving wave form for the liquid ejecting head in the liquid ejecting apparatus according to Example 1 of the present disclosure.

FIG. 7 is an enlarged plan view illustrating a region serving for one nozzle of a liquid ejecting head in a liquid ejecting apparatus according to Example 2 of the present disclosure.

FIG. 8 is a schematic view illustrating a driving wave form for the liquid ejecting head in the liquid ejecting apparatus according to Example 2 of the present disclosure.

FIG. 9 is an enlarged front view schematically illustrating a region serving for one nozzle of a liquid ejecting head in a liquid ejecting apparatus according to Example 3 of the present disclosure.

FIG. 10 is an enlarged front view schematically illustrating a region serving for one nozzle of a liquid ejecting head in a liquid ejecting apparatus according to Example 4 of the present disclosure.

FIG. 11 is an enlarged plan view schematically illustrating a region serving for one nozzle of a liquid ejecting head in a liquid ejecting apparatus according to Example 5 of the present disclosure.

### DESCRIPTION OF EXEMPLARY EMBODIMENTS

First, the present disclosure is outlined as follows. According to a first aspect of the present disclosure, a liquid ejecting head includes a chamber forming portion in which a pressure chamber is formed, the pressure chamber being provided with a supply port for supplying a liquid thereto and a nozzle for ejecting the liquid therefrom, an diaphragm that has a first surface being a wall surface of the pressure chamber and a second surface opposite to the first surface and that oscillates and thereby applies pressure to the pressure chamber, support walls that are disposed so as to be in contact with the second surface and so as to protrude in a direction intersecting the second surface, and piezoelectric elements that are disposed at the diaphragm and that oscillates the diaphragm. In the liquid ejecting head, the support walls and the piezoelectric elements are provided so as to serve for the pressure chamber, and longitudinal directions of the support walls are parallel to corresponding longitudinal directions of the piezoelectric elements.

According to this configuration, the support walls are disposed so as to protrude in a direction intersecting the second surface of the diaphragm and so as to extend in the longitudinal directions of the piezoelectric elements, and the support walls thereby serve to suppress a decrease in the rigidity of the structure having the pressure chambers. In addition, multiple piezoelectric elements provided for a single pressure chamber can amplify the oscillation of the diaphragm without affecting the flow of the liquid in the pressure chamber, which leads to an improvement in the liquid ejection capability.

According to a second aspect of the present disclosure, the liquid ejecting head according to the first aspect is configured such that the piezoelectric elements is formed at the first surface.

According to this configuration, the piezoelectric elements are formed on the first surface. Accordingly, in the manufacturing process of the liquid ejecting head, the piezoelectric elements can be formed on the diaphragm without being affected by the presence of the support walls, which simplifies formation of the piezoelectric elements on the diaphragm and thereby simplifies production of the liquid ejecting heads.

According to a third aspect of the present disclosure, the liquid ejecting head according to the first aspect is configured such that the piezoelectric elements is formed between respective adjacent ones of the support walls on the second surface.

According to this configuration, the piezoelectric elements are formed on the second surface, which can easily prevent the piezoelectric elements from coming into contact with the liquid. In addition, the piezoelectric elements can be formed efficiently on the diaphragm since the piezoelectric elements are disposed at positions between adjacent support walls.

According to a fourth aspect of the present disclosure, the liquid ejecting head according to any one of the first to the third aspects is configured such that the relation H>W holds, wherein H is an average distance between the diaphragm and a surface opposing the diaphragm in the pressure chamber, and W is an average distance between adjacent ones of the support walls.

According to this configuration, the distance between adjacent support walls can be decreased, which enables a large number of support walls to be arranged efficiently. Accordingly, the decrease of rigidity of the structure having pressure chambers can be suppressed effectively.

According to a fifth aspect of the present disclosure, the liquid ejecting head according to any one of the first to the fourth aspects is configured such that the piezoelectric elements is disposed such that a longitudinal direction of the pressure chamber is parallel to the longitudinal directions of the piezoelectric elements.

According to this configuration, the piezoelectric elements are disposed such that the longitudinal directions thereof are made parallel to the longitudinal direction of the pressure chamber, which enables the piezoelectric elements to be disposed densely and also enables the amount of oscillation of the diaphragm to increase effectively. Thus, the liquid ejection capability can be improved.

According to a sixth aspect of the present disclosure, the liquid ejecting head according to any one of the first to the fifth aspects is configured such that the support walls are joined to each other on a side opposite to the second surface.

According to this configuration, the support walls are joined to each other on the side opposite to the second surface, which enables the rigidity of the support walls to increase.

According to a seventh aspect of the present disclosure, the liquid ejecting head according to the sixth aspect is configured such that spaces defined by adjacent ones of the support walls are enclosed due to the support walls being joined to each other on the side opposite to the second surface.

According to this configuration, the spaces defined by adjacent support walls are enclosed, which can increase the rigidity of the structure in which the spaces are enclosed by the support walls.

According to an eighth aspect of the present disclosure, the liquid ejecting head according to the sixth or the seventh aspect is configured to include a chamber forming portion in which a plurality of the pressure chambers are formed so as to be adjacent to each other and partition walls that are disposed so as to serve as partitions for separating the pressure chambers from each other. In addition, the partition walls are joined to the support walls on the side opposite to the second surface and has a rigidity higher than that of the support walls, and the diaphragm is fixed to the partition walls.

According to this configuration, the diaphragm is fixed to the rigid partition walls, which can increase the rigidity of the structure having the spaces between partition walls to increase.

According to a ninth aspect of the present disclosure, the liquid ejecting head according to any one of the first to the eighth aspects is configured such that the pressure chamber has a tapered shape as viewed in the longitudinal directions of the piezoelectric elements.

A liquid tends to stagnate at end portions of each pressure chamber as viewed in the direction intersecting the longitudinal directions of the piezoelectric elements. According to this configuration, however, the pressure chamber has a tapered shape as viewed in the longitudinal directions of the piezoelectric elements, which can suppress the stagnation of the liquid at the end portions.

According to a tenth aspect of the present disclosure, a liquid ejecting apparatus includes the liquid ejecting head according to any one of the first to the eighth aspects.

With this configuration, the liquid ejecting apparatus can use the liquid ejecting head, for ejecting the liquid onto a medium, in which the liquid ejection capability is improved without sacrificing the rigidity of the structure having the pressure chambers.

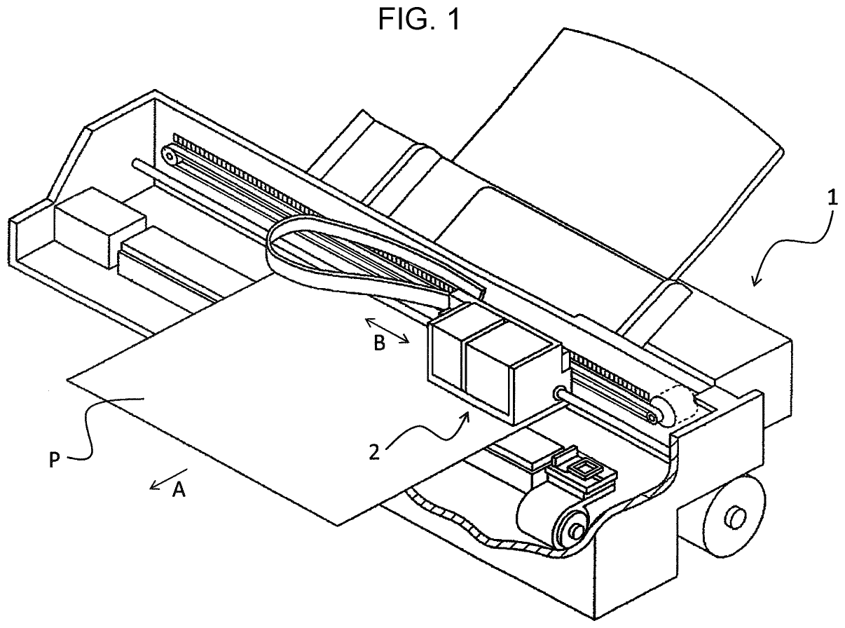

### Example 1 (see FIGS. 1 to 6)

Embodiments according to the present disclosure will be described with reference to the drawings. First, a liquid ejecting apparatus 1 according to Example 1 of the present disclosure will be outlined with reference to FIG. 1.

The liquid ejecting apparatus 1 of the present example forms an image on a medium P transported by a transporting unit (not illustrated) in a medium transporting direction A. The liquid ejecting apparatus 1 reciprocally moves a carriage in a direction B that intersects the transporting direction A, and a liquid ejecting head 2 disposed in the carriage ejects ink or a liquid onto a surface of the medium P that faces the liquid ejecting head 2. More specifically, while the liquid ejecting apparatus 1 intermittently transports the medium P in the transporting direction A, the liquid ejecting apparatus 1 performs recording by reciprocally moving the carriage and the liquid ejecting head 2 mounted thereon in the direction B and ejecting ink from a plurality of nozzles N, which will be described later.

Accordingly, the liquid ejecting apparatus 1 of the present example is a so-called serial printer that performs printing by alternately repeating the transport of the medium P by a predetermined amount and the reciprocal movement of the carriage. However, the liquid ejecting apparatus 1 may be a so-called line printer that performs printing continuously by using a line head in which nozzles N are arranged in a row extending in the direction B while transporting a medium P unintermittently.

The liquid ejecting apparatus 1 of the present example is configured to form an image on a medium P while transporting the medium P to the liquid ejecting head 2. However, the liquid ejecting apparatus 1 may be configured to move the liquid ejecting head 2 with respect to a medium P or to move both the liquid ejecting head 2 and a medium P.

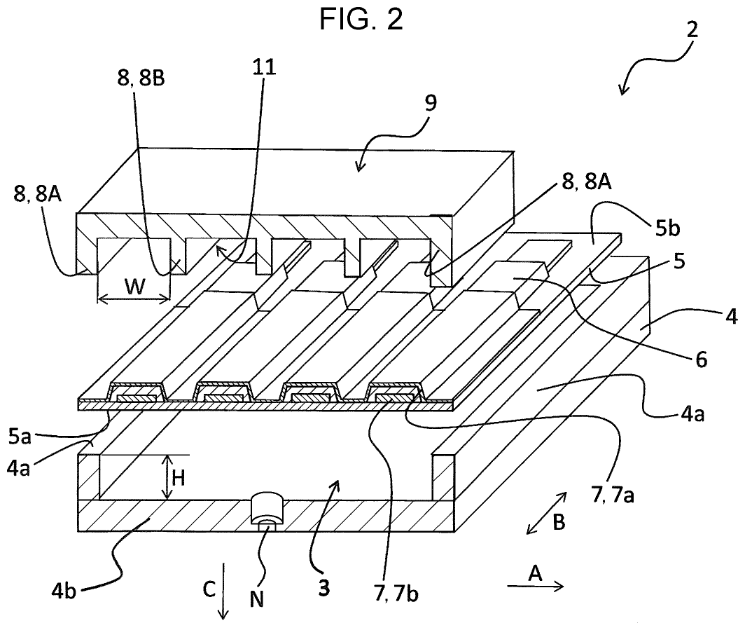

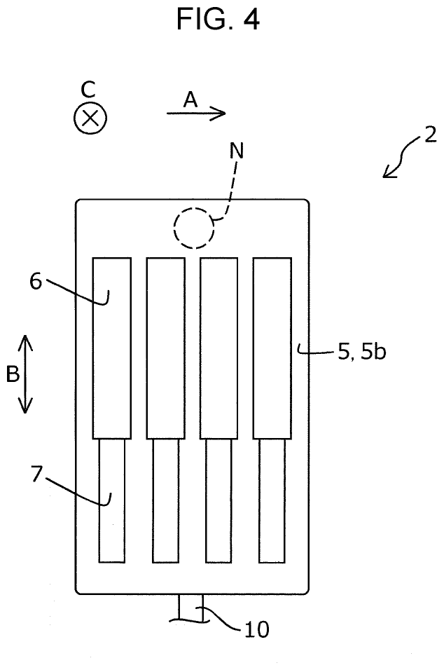

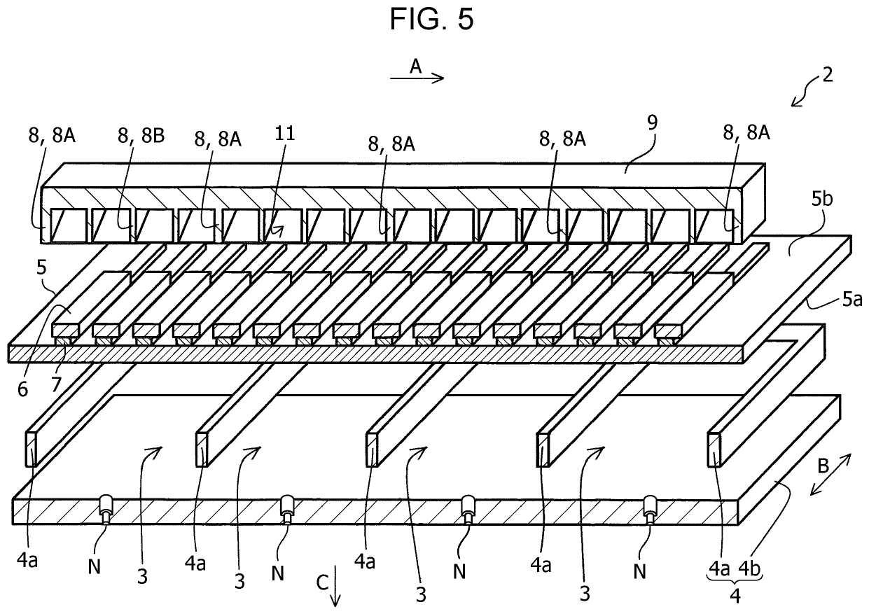

Next, a configuration of the liquid ejecting head 2, which is a principal part of the liquid ejecting apparatus 1 of the present example, will be described in detail with reference to FIGS. 2 to 5. Note that FIGS. 2 to 4 illustrate only a region in the liquid ejecting head 2 that serves for one nozzle. On the other hand, FIG. 5 illustrates a region corresponding to a plurality of nozzles in the liquid ejecting head 2. In addition, in FIGS. 4 and 5, an accommodation-chamber forming substrate 9 and an upper electrode 7a are omitted.

As illustrated in FIGS. 2, 3, and 5, the liquid ejecting head 2 of the present example includes a flow-path forming substrate 4, an accommodation-chamber forming substrate 9, and an diaphragm 5 formed so as to be interposed between the flow-path forming substrate 4 and the accommodation-chamber forming substrate 9. The flow-path forming substrate 4 includes a bottom portion 4b in which nozzles N are formed and side portions 4a that protrude in an ejection direction C in which ink is ejected from the bottom portion 4b. Pressure chambers 3 are formed by fixing a first surface 5a of the diaphragm 5 to the side portions 4a of the above-configured flow-path forming substrate 4 at positions opposite to the side of the bottom portion 4b. The liquid ejecting head 2 of the present example is configured to apply pressure to each one of the pressure chambers 3 by oscillating the diaphragm 5 and thereby eject ink from each nozzle N.

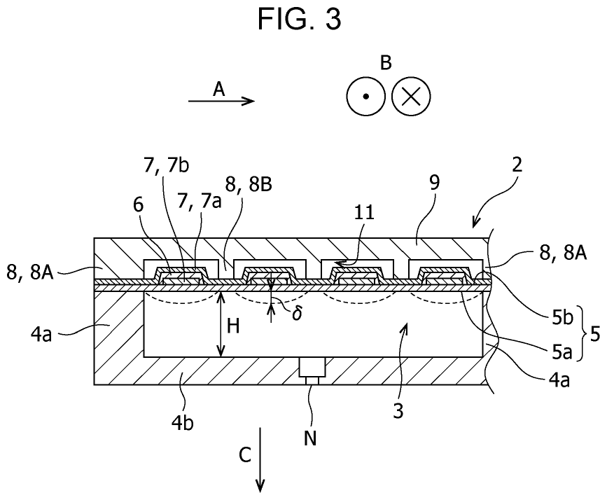

As illustrated in FIG. 4, the longitudinal direction of each region that serves for one nozzle in the liquid ejecting head 2, in other words, the longitudinal direction of each pressure chamber 3, is parallel to the direction B. A nozzle N is formed in an end region of the pressure chamber 3 in the longitudinal direction, and a supply port 10 for supplying ink to the pressure chamber 3 is formed in the opposite end region of the pressure chamber 3. Accordingly, ink flows in the pressure chamber 3 substantially in the direction B. As illustrated in FIGS. 2 and 3, lower electrodes 7b, piezoelectric elements 6, and an upper electrode 7a are laminated on a second surface 5b of the diaphragm 5. As illustrated in FIG. 4, the longitudinal direction of each piezoelectric element 6 is also parallel to the direction B. Accordingly, in the liquid ejecting head 2 of the present example, each piezoelectric element 6 is disposed in such a manner that the longitudinal direction thereof is parallel to the longitudinal direction of the pressure chamber 3. In FIG. 3, the lower electrodes 7b are individual electrodes, and the upper electrode 7a is a common electrode. However, a lower electrode 7b may be the common electrode, and upper electrodes 7a may be the individual electrodes.

As described above, the piezoelectric elements 6 are formed on the second surface 5b of the diaphragm 5, and the accommodation-chamber forming substrate 9 is also disposed on the second surface 5b of the diaphragm 5. As illustrated in FIGS. 2 and 3, the accommodation-chamber forming substrate 9 includes a plurality of wall portions 8 arranged in the transporting direction A. The wall portions 8 are constituted by partition walls 8A and support walls 8B disposed between the partition walls 8A. The partition walls 8A oppose the side portions 4a that are formed as side walls of each pressure chamber 3. The partition walls 8A and the support walls 8B each protrude in the ejection direction C and longitudinally extend in the direction B. Each amount of protrusion in the ejection direction C is substantially the same. The support walls 8B are configured to be brought into contact with the second surface 5b of the diaphragm 5 when the partition walls 8A are fixed to the diaphragm 5.

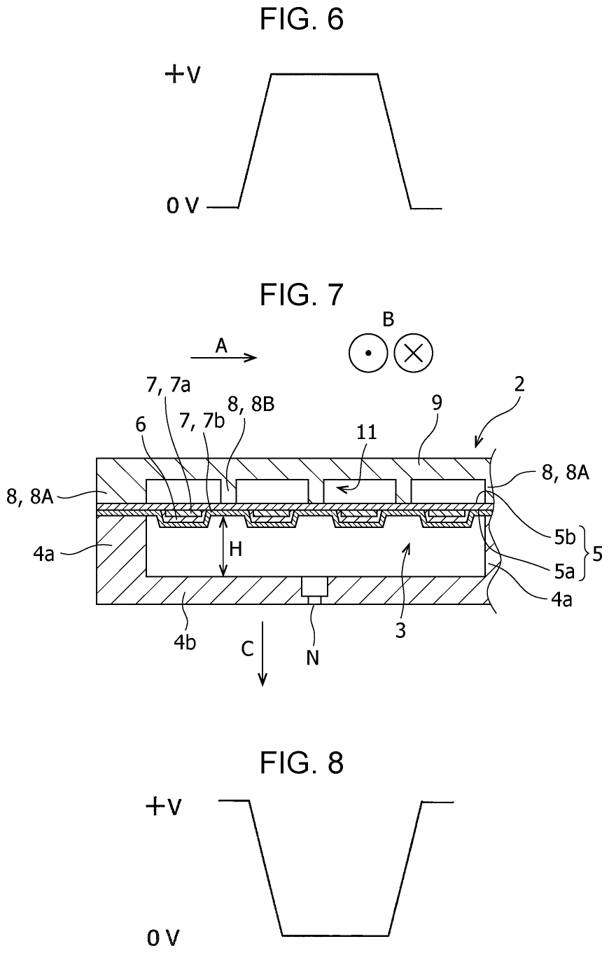

Spaces separated by the partition walls 8A and the support walls 8B are accommodation chambers 11 for accommodating the piezoelectric elements 6. In the liquid ejecting head 2 of the present example, the piezoelectric elements 6 are disposed in all of respective accommodation chambers 11, in other words, all of respective spaces separated by the partition walls 8A and the support walls 8B. However, some of the spaces may not include the piezoelectric elements 6. Application of driving wave forms as illustrated in FIG. 6 causes each piezoelectric element 6 to deform, which thereby oscillates the diaphragm 5. Accordingly, as the number of the piezoelectric elements 6 increases, the diaphragm 5 can be oscillated more effectively, and the amount of change in the volume of the pressure chamber 3 can be increased. As a result, the amount of ink ejected can be increased. Note that the dashed line in FIG. 3 conceptually indicates a state in which the diaphragm 5 is deformed by an amount 6 due to each piezoelectric element 6 being deformed by application of the driving wave form.

Here, the above description is summarized as follows. The liquid ejecting head 2 of the present example includes the pressure chambers 3 in each of which an ink supply port 10 and an ink ejecting nozzle N are formed. The liquid ejecting head 2 also includes the diaphragm 5 of which the first surface 5a forms the wall surface of the pressure chambers 3. The diaphragm 5 oscillates and thereby applies pressure to each of the pressure chambers 3. The liquid ejecting head 2 further includes the support walls 8B that are disposed so as to be in contact with the second surface 5b of the diaphragm 5, which is the surface opposite to the first surface 5a. The support walls 8B protrude in the ejection direction C that intersects the second surface 5b. The liquid ejecting head 2 further includes the piezoelectric elements 6 that are formed on the diaphragm 5 and that oscillate the diaphragm 5. Multiple support walls 8B and multiple piezoelectric elements 6 are provided for each one of the pressure chambers 3. The support walls 8B extend in the longitudinal directions of the piezoelectric elements 6. Accordingly, in the liquid ejecting head 2 of the present example, the support walls 8B, which are disposed so as to protrude in a direction intersecting the second surface 5b and so as to extend in the longitudinal directions of the piezoelectric elements 6, suppresses the decrease of rigidity of the structure having the pressure chambers 3. In addition, multiple piezoelectric elements 6 provided for a single pressure chamber 3 oscillate the diaphragm 5, which can increase the amount of change in the volume of each pressure chamber 3 without affecting the flow of ink in the pressure chamber 3 and can improve liquid ejection capability.

To put it from the viewpoint of the liquid ejecting apparatus 1, the liquid ejecting apparatus 1 of the present example includes the liquid ejecting head 2 configured as described above and can use the liquid ejecting head 2 for ejecting ink onto a medium P. Accordingly, the liquid ejecting apparatus 1 can improve liquid ejection capability without sacrificing the rigidity of the structure having the pressure chambers 3.

In addition, the liquid ejecting head 2 of the present example further includes the accommodation-chamber forming substrate 9 on which multiple wall portions 8 are formed. In other words, in the liquid ejecting head 2 of the present example, the support walls 8B are joined to each other on a side opposite to the side facing the second surface 5b of the diaphragm 5. This increases the rigidity of each support wall 8B in the liquid ejecting head 2 of the present example.

In addition, since the support walls 8B are joined to each other on the side opposite to the side facing the second surface 5b of the diaphragm 5, the accommodation chambers 11 or the spaces separated by the support walls 8B in the liquid ejecting head 2 of the present example are formed as enclosed spaces. This increases the rigidity of the structure having the accommodation chambers 11 that are the spaces surrounded by the support walls 8B.

As illustrated in FIG. 5, the liquid ejecting head 2 of the present example is structured so as to include multiple pressure chambers 3 that are arranged in a direction intersecting the longitudinal direction of the pressure chambers 3. In addition, as illustrated in FIG. 3, the partition walls 8A are formed so as to be thicker and more rigid than the support walls 8B. The partition walls 8A are fixed to the side portions 4a, which serve as partitions for separating pressure chambers 3 from each other, in such a manner that the diaphragm 5 is interposed between the partition walls 8A and the side portions 4a. In other words, the diaphragm 5 is fixed to the partition walls 8A having a high rigidity. Accordingly, in the liquid ejecting head 2 of the present example, the diaphragm 5 is fixed to the rigid partition walls 8A, which increases the entire rigidity of the structure having the accommodation chambers 11 that are the spaces between partition walls 8A. However, the present disclosure is not limited to the structure in which the diaphragm 5 is fixed to the partition walls 8A. In the present example, as viewed in the longitudinal direction of the piezoelectric elements 6, the width of each partition wall 8A is increased compared with the width of each support wall 8B in order to increase the rigidity of the partition wall 8A than that of the support wall 8B. However, the rigidity of the partition wall 8A may be increased than that of the support walls 8B by using a material different from that of the support walls 8B.

In addition, in the liquid ejecting head 2 of the present example, the piezoelectric elements 6 are formed on the second surface 5b of the diaphragm 5 between the support walls 8B. Accordingly, the simple structure in which the piezoelectric elements 6 are formed on the second surface 5b of the diaphragm 5 prevents the piezoelectric elements 6 from coming into contact with ink. In addition, disposing piezoelectric elements 6 at positions between adjacent support walls 8B enables the piezoelectric elements 6 to be formed efficiently on the diaphragm 5.

In the liquid ejecting head 2 of the present example, as illustrated in FIG. 3, reference H denotes an average distance between the diaphragm 5 and the surface of the bottom portion 4b that opposes the diaphragm 5 in each pressure chamber 3, and reference W denotes an average distance between adjacent support walls 8B. In this case, H is greater than W. The liquid ejecting head 2 of the present example having this configuration enables the distance between adjacent support walls 8B to decrease, which leads to efficient arrangement of a large number of support walls 8B. Accordingly, the liquid ejecting head 2 of the present example effectively suppresses the decrease of rigidity of the structure having the pressure chambers 3 without reducing the amount of change in the volume of each pressure chamber 3. In addition, the liquid ejecting head 2 of the present example has the structure in which the piezoelectric elements 6 are disposed on the second surface 5b of the diaphragm 5 between adjacent support walls 8B, which enables the piezoelectric elements 6 to be disposed densely and thereby shortens a nozzle pitch, which is a spacing between adjacent nozzles N. Thus, the amount of change in the volume of each pressure chamber 3 caused by the diaphragm 5 can be increased effectively, and the liquid ejection capability can be improved effectively. As described above, in the present example, reference H denotes the average distance between the diaphragm 5 and the surface of the bottom portion 4b that opposes the diaphragm 5 in each pressure chamber 3. However, when a nozzle N is formed in the bottom portion 4b as in the liquid ejecting head 2 of the present example, reference H may denote the distance between the diaphragm 5 and the surface of the bottom portion 4b at the position where the nozzle N is formed.

In the liquid ejecting head 2 of the present example, as illustrated in FIG. 4, each piezoelectric element 6 is disposed such that the longitudinal direction of the piezoelectric element 6 is made parallel to the longitudinal direction of the pressure chamber 3. Due to the structure in which the piezoelectric element 6 is disposed such that the longitudinal direction thereof is made parallel to the longitudinal direction of the pressure chamber 3 as in the liquid ejecting head 2 of the present example, the piezoelectric elements 6 can be disposed densely and the nozzle pitch can be shortened. Thus, the amount of change in the volume of each pressure chamber 3 caused by the diaphragm 5 can be increased effectively, and the liquid ejection capability can be further improved. The liquid ejecting head 2 of the present example is configured such that the piezoelectric elements 6 are formed on the second surface 5b of the diaphragm 5 between adjacent support walls 8B while the relation H>W holds. This enables the piezoelectric elements 6 to be disposed densely, the nozzle pitch to be shortened, and the oscillation amplitude of diaphragm 5 to be increased especially effectively. As the synergistic effect of these, the liquid ejection capability can be improved especially effectively. By contrast, if the piezoelectric element 6 are disposed such that the longitudinal direction of each piezoelectric element 6 is made parallel to the lateral direction of each pressure chamber 3, the nozzle pitch inevitably becomes longer. Moreover, the durability of the liquid ejecting head 2 may decrease due to stresses concentrating at the ends of the piezoelectric elements 6. In addition, if the piezoelectric element 6 are disposed such that the longitudinal direction of each piezoelectric element 6 is made parallel to the lateral direction of each pressure chamber 3, the electrodes 7 of each piezoelectric element 6 are likely to be disposed on the side portion 4a with the diaphragm 5 interposed between the electrodes 7 and the side portion 4a. In this case, the width of the side portion 4a needs to be increased in response to the number of the piezoelectric elements 6, which results in an increase in the nozzle pitch.

### Example 2 (see FIGS. 7 and 8)

Next, a liquid ejecting apparatus 1 according to Example 2 of the present disclosure will be described with reference to FIGS. 7 and 8. FIG. 7 is an enlarged plan view illustrating part of a liquid ejecting head 2 in the liquid ejecting apparatus 1 of the present example, which is a view corresponding to the liquid ejecting apparatus 1 of Example 1 in FIG. 3. The liquid ejecting apparatus 1 of the present example has the same configuration as that of the liquid ejecting apparatus 1 of Example 1 except for the liquid ejecting head 2. Accordingly, the description of the same configuration will be omitted. Note that elements that are same as those in Example 1 are denoted by the same references, and detailed descriptions will be omitted.

As described, the liquid ejecting head 2 in the liquid ejecting apparatus 1 of Example 1 is configured such that the piezoelectric elements 6 are formed on the second surface 5b of the diaphragm 5. On the other hand, as illustrated in FIG. 7, the liquid ejecting head 2 in the liquid ejecting apparatus 1 of the present example has the piezoelectric elements 6 formed on the first surface 5a of the diaphragm 5. Application of a driving wave form as illustrated in FIG. 8 causes each piezoelectric element 6 to deform. The diaphragm 5 is thereby oscillated and ink can be ejected from the corresponding nozzle N. The liquid ejecting head 2 of the present example has the structure in which the piezoelectric elements 6 are formed on the first surface 5a of the diaphragm 5. Accordingly, in the manufacturing process of the liquid ejecting head 2, the piezoelectric elements 6 can be formed more easily on the diaphragm 5 without being affected by the presence of the support walls 8B, which simplifies production of the liquid ejecting heads 2. Note that with the configuration of the present example, the piezoelectric elements 6 and a lower electrode 7b may come into contact with ink. Depending on a type of ink to be used, the piezoelectric element 6 and the lower electrode 7b may be covered by a coating so as not to be in contact with ink.

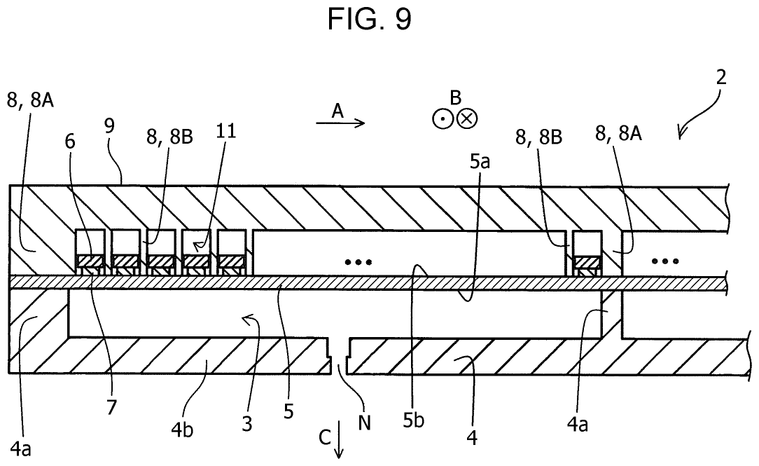

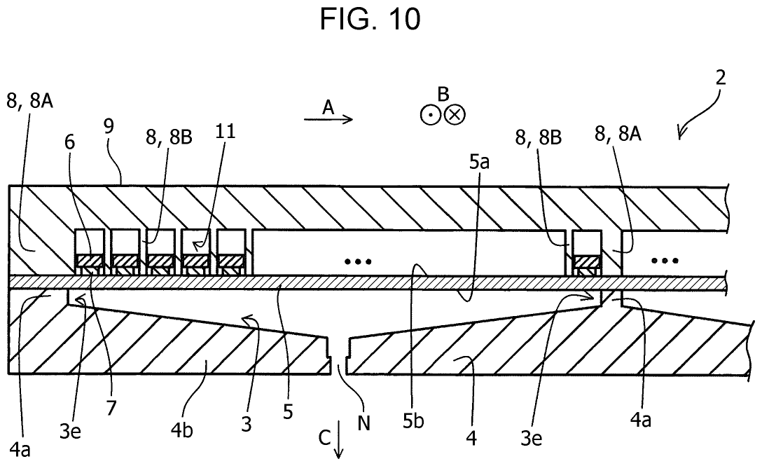

### Example 3 (see FIG. 9)

Next, a liquid ejecting apparatus 1 according to Example 3 will be described with reference to FIG. 9. FIG. 9 is an enlarged front view schematically illustrating part of a liquid ejecting head 2 in the liquid ejecting apparatus 1 of the present example, in which illustration of the upper electrode 7a is omitted. In other words, the electrodes 7 in the liquid ejecting apparatus 1 of the present example are configured to be the same as those of the liquid ejecting apparatus 1 of Example 1. The liquid ejecting apparatus 1 of the present example has the same configuration as those of the liquid ejecting apparatuses 1 of Example 1 and Example 2 except for the liquid ejecting head 2. Accordingly, the description of the same configuration will be omitted. Note that elements that are same as those in Example 1 and Example 2 are denoted by the same references, and detailed descriptions will be omitted.

As described, the liquid ejecting heads 2 in the liquid ejecting apparatuses 1 of Example 1 and Example 2 are configured such that four piezoelectric elements 6 are provided for a single pressure chamber 3. However, the number of the piezoelectric elements 6 provided for a single pressure chamber 3 is not limited insofar as multiple piezoelectric elements 6 are provided. The number of the piezoelectric elements 6 may be three or less or may be five or more. The greater the number of the piezoelectric elements 6 provided for the single pressure chamber 3, the greater the oscillation amplitude of the diaphragm 5. Accordingly, the liquid ejecting head can include a large number of piezoelectric elements 6 as is the case for the liquid ejecting head 2 of the present example illustrated in FIG. 9.

### Example 4 (see FIG. 10)

Next, a liquid ejecting apparatus 1 according to Example 4 will be described with reference to FIG. 10. FIG. 10 is an enlarged front view schematically illustrating part of a liquid ejecting head 2 in the liquid ejecting apparatus 1 of the present example, in which illustration of the upper electrode 7a is omitted. In other words, the electrodes 7 in the liquid ejecting apparatus 1 of the present example are configured to be the same as those of the liquid ejecting apparatus 1 of Example 1. The liquid ejecting apparatus 1 of the present example has the same configuration as those of the liquid ejecting apparatuses 1 of Examples 1 to 3 except for the liquid ejecting head 2. Accordingly, the description of the same configuration will be omitted. Note that elements that are same as those in Examples 1 to 3 are denoted by the same references, and detailed descriptions will be omitted.

As described, each pressure chamber 3 is shaped like a rectangular parallelepiped in the liquid ejecting heads 2 in the liquid ejecting apparatuses 1 of Examples 1 to 3. However, the shape of the pressure chamber 3 is not specifically limited. As illustrated in FIG. 10, in the liquid ejecting head 2 of the present example, each pressure chamber 3 has a tapered shape as viewed in the longitudinal direction of the piezoelectric element 6. Ink tends to stagnate at end portions 3e of each pressure chamber 3 as viewed in the direction intersecting the longitudinal direction of the piezoelectric element 6. In the liquid ejecting head 2 of the present example, however, the pressure chamber 3 has a tapered shape as viewed in the longitudinal direction of the piezoelectric element 6, which suppresses the stagnation of ink at the end portions 3e.

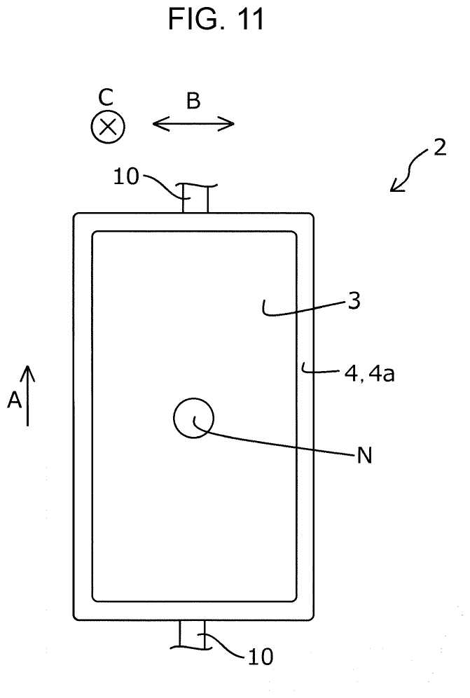

### Example 5 (see FIG. 11)

Next, a liquid ejecting apparatus 1 according to Example 5 will be described with reference to FIG. 11. FIG. 11 is an enlarged plan view schematically illustrating part of a liquid ejecting head 2 in the liquid ejecting apparatus 1 of the present example, in which illustration of the accommodation-chamber forming substrate 9 and the diaphragm 5 is omitted. The liquid ejecting apparatus 1 of the present example has the same configuration as those of the liquid ejecting apparatuses 1 of Examples 1 to 4 except for the liquid ejecting head 2. Accordingly, the description of the same configuration will be omitted. Note that elements that are same as those in Examples 1 to 4 are denoted by the same references, and detailed descriptions will be omitted.

In the liquid ejecting apparatuses 1 of Examples 1 to 4, the liquid ejecting heads 2 are configured such that a nozzle N is formed in an end region in each pressure chamber 3 in the longitudinal direction thereof, and a supply port 10 for supplying ink to the pressure chamber 3 is formed in the opposite end region in the pressure chamber 3. As illustrated in FIG. 11, the liquid ejecting head 2 of the present example may include a plurality of supply ports 10 to supply ink effectively to the pressure chamber 3. Note that the configuration of the liquid ejecting head 2 of the present example, such as the arrangement of piezoelectric elements 6 and the structure of the accommodation-chamber forming substrate 9, are similar to that of the liquid ejecting head 2 of Example 1. Also note that one of the supply ports 10 of Example 5 may be a discharge port.

Note that the present disclosure is not limited to the examples described above and various modifications can be made within the scope of the disclosure set forth in the claims. Thus, all such modifications are intended to be included within the scope of the disclosure.

What is claimed is:

1. A liquid ejecting head comprising:
a chamber forming portion in which a pressure chamber is formed, the pressure chamber being provided with a supply port for supplying a liquid thereto and a nozzle for ejecting the liquid therefrom;
an diaphragm that has a first surface being a wall surface of the pressure chamber and a second surface opposite to the first surface and that oscillates and thereby applies pressure to the pressure chamber;
support walls that are disposed so as to be in contact with the second surface and so as to protrude in a direction intersecting the second surface; and
piezoelectric elements that are disposed at the diaphragm and that oscillates the diaphragm, wherein
the support walls and the piezoelectric elements are provided so as to serve for the pressure chamber, and
longitudinal directions of the support walls are parallel to respective longitudinal directions of the piezoelectric elements.

2. The liquid ejecting head according to claim 1, wherein
the piezoelectric elements are formed at the first surface.

3. The liquid ejecting head according to claim 1, wherein
the piezoelectric elements are formed between respective adjacent ones of the support walls on the second surface.

4. The liquid ejecting head according to claim 1, wherein
H>W, wherein H is an average distance between the diaphragm and a surface opposing the diaphragm in the pressure chamber, and W is an average distance between adjacent ones of the support walls.

5. The liquid ejecting head according to claim 1, wherein
the piezoelectric elements are disposed such that a longitudinal direction of the pressure chamber is parallel to the longitudinal directions of the piezoelectric elements.

6. The liquid ejecting head according to claim 1, wherein
the support walls are joined to each other on a side opposite to the second surface.

7. The liquid ejecting head according to claim 6, wherein
spaces defined by adjacent ones of the support walls are enclosed due to the support walls being joined to each other on the side opposite to the second surface.

8. The liquid ejecting head according to claim 6, wherein
the liquid ejecting head comprises
a chamber forming portion in which a plurality of the pressure chambers are formed so as to be adjacent to each other, and
partition walls that are disposed so as to serve as partitions for separating the pressure chambers from each other, the partition walls being joined to the support walls on the side opposite to the second surface and having a rigidity higher than that of the support walls, and
the diaphragm is fixed to the partition walls.

9. The liquid ejecting head according to claim 1, wherein
the pressure chamber has a tapered shape as viewed in the longitudinal directions of the piezoelectric elements.

10. A liquid ejecting apparatus, comprising
the liquid ejecting head according to claim 1.
